(19) United States
(12) Patent Application Publication
(10) Pub. No.: US 2011/0305507 A1
(43) Pub. Date: Dec. 15, 2011

(54) COOLING FAN BEARING RETAINER RING STRUCTURE

(76) Inventor: Changde Li, Sinjhuang CIty (TW)

(21) Appl. No.: 12/815,610

(22) Filed: Jun. 15, 2010

(51) Int. Cl. F16B 7/04

(52) U.S. Cl. 403/376

(57) ABSTRACT

A cooling fan bearing retainer ring structure includes: a bearing seat having a bearing cup perpendicularly extending from one side of the bearing seat, the bearing cup having an upper end, a lower end and a first shaft hole, a protrusion section being formed on inner circumference of the bearing cup near the upper end of the bearing cup and radially protruding toward a center thereof; a retainer ring disposed in the first shaft hole and having a first side in abutment with the protrusion section, a second side, a central hole and at least one retainer tongue annularly disposed in the central hole; and a bearing positioned in the first shaft hole in tight contact with the retainer ring. The bearing has a first end in abutment with the second side of the retainer ring, a second end and a second shaft hole axially extending through the bearing.

### FIELD OF THE INVENTION

The present invention relates generally to a cooling fan bearing retainer ring structure, and more particularly to a cooling fan bearing retainer ring structure, which can securely fix the bearing in the bearing cup without occupying much room. Therefore, the volume of the cooling fan can be reduced to slim the cooling fan.

### BACKGROUND OF THE INVENTION

A conventional cooling fan includes a stator, a rotor and a fan frame body. The rotor is coupled with a fan propeller via a shaft. The fan frame body has a bearing cup in which at least one bearing is disposed. The stator is fitted around the bearing cup. The shaft is rotatably supported and fitted in the bearing, whereby the fan propeller can stably rotate about the fan frame body.

In order to smoothen the rotation of the shaft within the bearing, a lubricant is often applied between the shaft and the bearing.

In the existent cooling fan, the bearing is generally fitted in the bearing cup with one end of the shaft fitted through the bearing. A retainer ring is latched with the other end of the shaft to restrict the shaft from axially moving. Such structure necessitates a larger room. As a result, the total volume of the cooling fan is increased. Moreover, the assembling process of the cooling fan is complicated and the ratio of defective products is increased. This makes it impossible to slim the cooling fan.

Furthermore, the wear plate is disposed at the bottom of the bearing cup without being fixed. As a result, the cooling fan will make a noise in operation. In the case that the bearing is assembled with the bearing cup by loose-fit connection, it is necessary to dispense glue between the bearing and the bearing cup. In the manufacturing process, it is hard to avoid spilling of the glue. The spilling of the glue will cause clogging of the shaft. As a result, the ratio of defective products is increased.

According to the aforesaid, the conventional cooling fan has the following shortcomings:

1. It is impossible to slim the cooling fan.
2. The glue is likely to spill.
3. The cooling fan has a considerable thickness.

### SUMMARY OF THE INVENTION

A primary object of the present invention is to provide a cooling fan bearing retainer ring structure, which can fix the bearing in the bearing cup without occupying much room. Therefore, the volume of the cooling fan can be reduced to slim the cooling fan.

A further object of the present invention is to provide the above cooling fan bearing retainer ring structure, which can securely fix the bearing in the bearing cup to increase the ratio of good products of cooling fans.

To achieve the above and other objects, the cooling fan bearing retainer ring structure of the present invention includes a bearing seat, a retainer ring and a bearing. The bearing seat has a bearing cup perpendicularly extending from one side of the bearing seat. The bearing cup has an upper end and a lower end and a first shaft hole. The first shaft hole axially extends through the bearing cup between the upper end and the lower end. A protrusion section is formed on an inner circumference of the bearing cup near the upper end thereof. The protrusion section radially protrudes from the inner circumference of the bearing cup toward a center thereof. The retainer ring is disposed in the first shaft hole. The retainer ring has a first side, a second side, a central hole and at least one retainer tongue. The first side abuts against the protrusion section. The retainer tongue is annularly disposed in the central hole. The bearing is positioned in the first shaft hole in tight contact with the retainer ring. The bearing has a first end, a second end and a second shaft hole. The first end abuts against the second side of the retainer ring. The second shaft hole axially extends through the bearing. The retainer ring and the protrusion section together fix the bearing in the bearing cup without occupying much room. Therefore, the volume of the cooling fan can be reduced to slim the cooling fan. In addition, the cooling fan bearing retainer ring structure is able to securely fix the bearing in the bearing cup to increase the ratio of good products of cooling fans.

According to the aforesaid, the cooling fan bearing retainer ring structure of the present invention has the following advantages:

1. The height of the cooling fan is reduced.
2. The ratio of good products is increased.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the cooling fan bearing retainer ring structure of the present invention;

FIG. 2 is a sectional view of the first embodiment of the cooling fan bearing retainer ring structure of the present invention;

FIG. 3 is a sectional view of a second embodiment of the cooling fan bearing retainer ring structure of the present invention;

FIG. 4 is a sectional view of a third embodiment of the cooling fan bearing retainer ring structure of the present invention; and

FIG. 5 is a sectional view of a fourth embodiment of the cooling fan bearing retainer ring structure of the present invention.

### DETAILED DESCRIPTION OF THE PREFERRED EMBODIMENTS

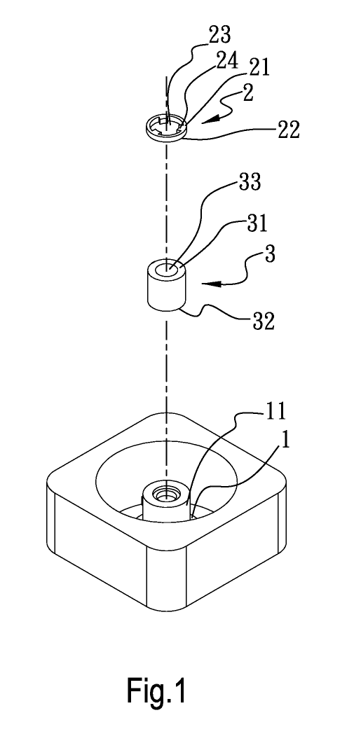

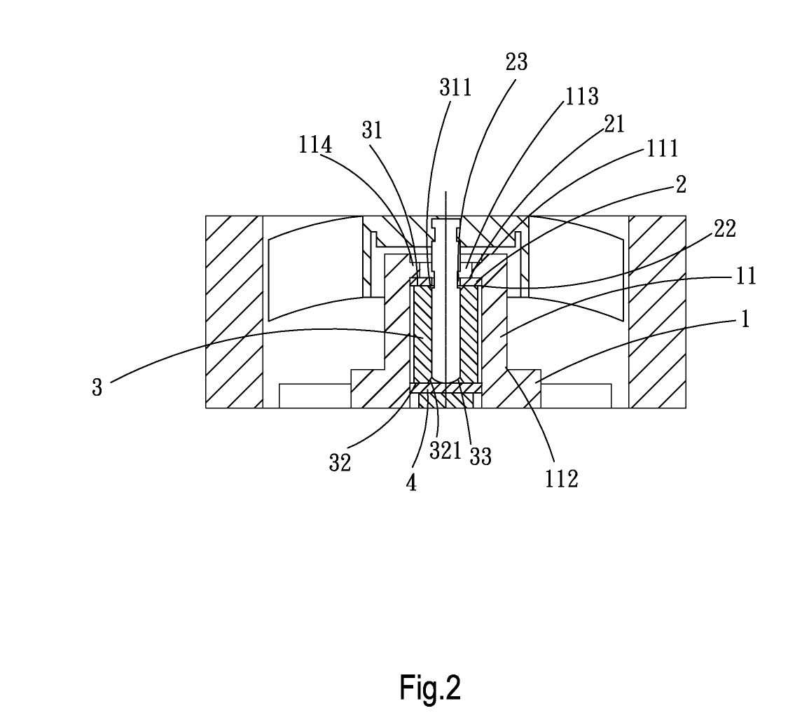

Please refer to FIGS. 1 and 2. According to a first embodiment, the cooling fan bearing retainer ring structure of the present invention includes a bearing seat 1, a retainer ring 2 and a bearing 3.

The bearing seat 1 has a bearing cup 11 perpendicularly extending from one side of the bearing seat 1. The bearing cup 11 has an upper end 111 and a lower end 112 and a first shaft hole 113. The first shaft hole 113 axially extends through the bearing cup 11 between the upper end 111 and the lower end 112. A protrusion section 114 is formed on an inner circumference of the bearing cup 11 near the upper end 111 thereof. The protrusion section 114 radially protrudes from the inner circumference of the bearing cup 11 toward a center thereof.

The retainer ring 2 is disposed in the first shaft hole 113. The retainer ring 2 has a first side 21, a second side 22, a central hole 23 and at least one retainer tongue 24. The first side 21 abuts against the protrusion section 114. The retainer tongue 24 is annularly disposed in the central hole 23.

The bearing 3 is positioned in the first shaft hole 113 in tight contact with the retainer ring 2. The bearing 3 has a first end 31, a second end 32 and a second shaft hole 33. The first end 31 abuts against the second side 22 of the retainer ring 2. The second shaft hole 33 axially extends through the bearing 3.

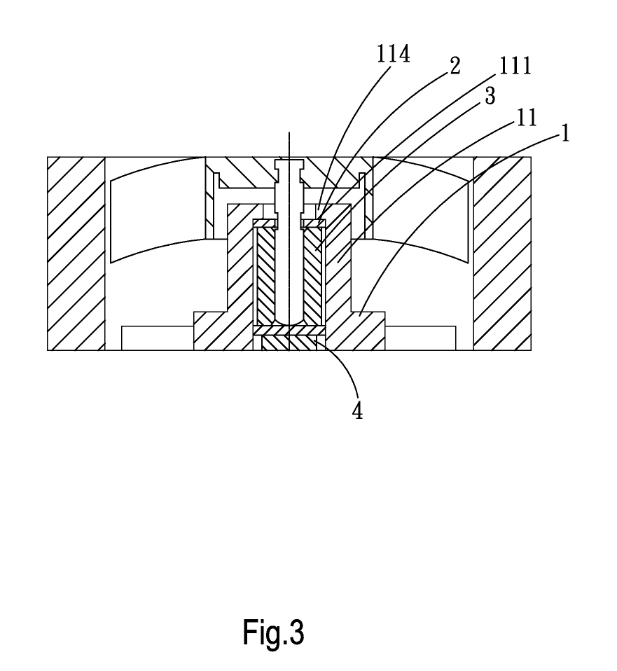

Please refer to FIG. 3, which is a sectional view of a second embodiment of the cooling fan bearing retainer ring structure of the present invention. In this embodiment, the cooling fan bearing retainer ring structure includes a bearing seat 1, a retainer ring 2 and a bearing 3, which are substantially identical to those of the first embodiment in structure and deployment. The second embodiment is only different from the first embodiment in that the protrusion section 114 is formed on the inner circumference of the bearing cup 11 in immediate adjacency to the upper end 111 thereof. The protrusion section 114 radially protrudes from the inner circumference of the bearing cup 11 toward a center thereof. The retainer ring 2 abuts against the protrusion section 114 to press and fix the bearing 3.

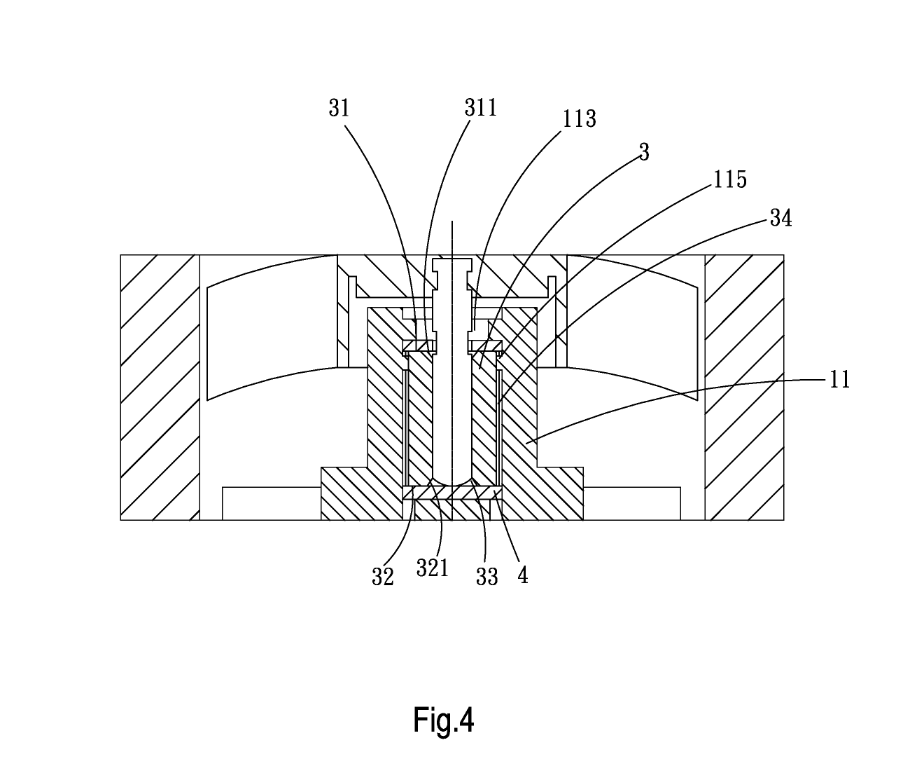

Please refer to FIG. 4, which is a sectional view of a third embodiment of the cooling fan bearing retainer ring structure of the present invention. In this embodiment, at least one axially extending rib 115 is disposed on an inner wall of the first shaft hole 113. At least one axially extending groove 34 is formed on an outer circumference of the bearing 3 corresponding to the rib 115. The rib 115 is inlaid in the groove 34 of the bearing 3.

In any of the first, second and third embodiments, the protrusion section 114 is continuously or discontinuously (not shown) annularly disposed on the inner circumference of the bearing cup 11.

The bearing 3 is selected from the group consisting of oil-retaining powder bearing, ball bearing and ceramic bearing. In the first, second and third embodiments, the bearing 3 is, but not limited to, an oil-retaining powder bearing for illustration only.

At least one wear plate 4 is disposed at the bottom of the bearing cup 3 in abutment with the second end 32 of the bearing 3.

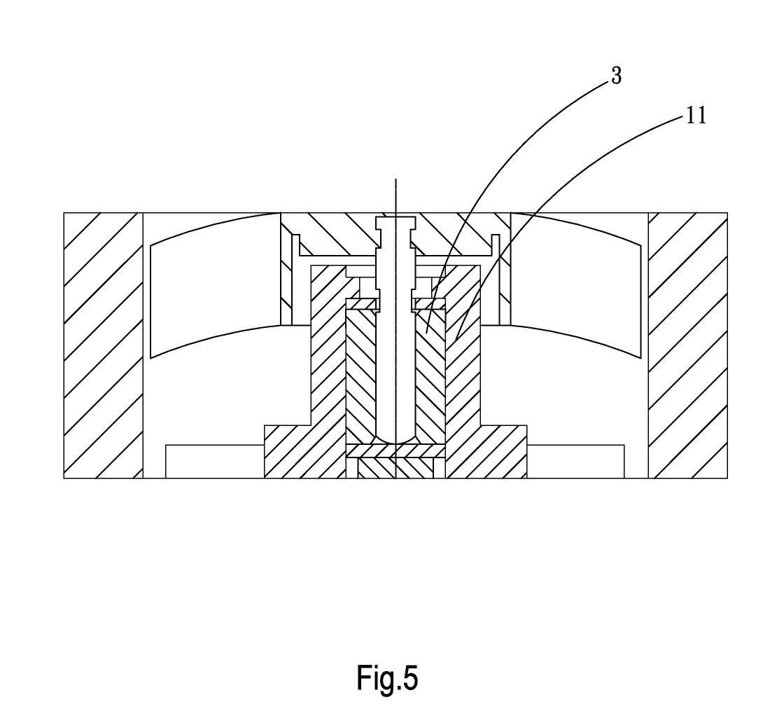

The bearing 3 can be selectively assembled with the bearing cup 11 by means of press-fit connection (as shown in FIG. 5) or loose-fit connection (as shown in FIGS. 1 and 2).

The first end 31 of the bearing 3 has a first tapered hole 311 and the second end 32 of the bearing 3 has a second tapered hole 321. The first and second tapered holes 311, 321 communicate with the second shaft hole 33.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. A cooling fan bearing retainer ring structure comprising:
a bearing seat having a bearing cup perpendicularly extending from one side of the bearing seat, the bearing cup having an upper end and a lower end and a first shaft hole, the first shaft hole axially extending through the bearing cup between the upper end and the lower end, a protrusion section being formed on an inner circumference of the bearing cup near the upper end thereof, the protrusion section radially protruding from the inner circumference of the bearing cup toward a center thereof;
a retainer ring disposed in the first shaft hole, the retainer ring having a first side, a second side, a central hole and at least one retainer tongue, the first side abutting against the protrusion section, the retainer tongue being annularly disposed in the central hole; and
a bearing positioned in the first shaft hole in tight contact with the retainer ring, the bearing having a first end, a second end and a second shaft hole, the first end abutting against the second side of the retainer ring, the second shaft hole axially extending through the bearing.

2. The cooling fan bearing retainer ring structure as claimed in claim 1, wherein at least one axially extending rib is disposed on an inner wall of the first shaft hole and at least one axially extending groove is formed on an outer circumference of the bearing corresponding to the rib.

3. The cooling fan bearing retainer ring structure as claimed in claim 1, wherein the protrusion section is continuously or discontinuously annularly disposed on the inner circumference of the bearing cup.

4. The cooling fan bearing retainer ring structure as claimed in claim 1, wherein the bearing is selected from the group consisting of oil-retaining powder bearing, ball bearing and ceramic bearing.

5. The cooling fan bearing retainer ring structure as claimed in claim 1, wherein at least one wear plate is disposed at a bottom of the bearing cup in abutment with the second end of the bearing.

6. The cooling fan bearing retainer ring structure as claimed in claim 1, wherein the first end of the bearing has a first tapered hole and the second end of the bearing has a second tapered hole, the first and second tapered holes communicating with the second shaft hole.

7. A cooling fan bearing retainer ring structure comprising:
a bearing seat having a bearing cup perpendicularly extending from one side of the bearing seat, the bearing cup having an upper end and a lower end and a first shaft hole, the first shaft hole axially extending through the bearing cup between the upper end and the lower end, a protrusion section being formed on an inner circumference of the bearing cup in immediate adjacency to the upper end thereof, the protrusion section radially protruding from the inner circumference of the bearing cup toward a center thereof;
a retainer ring disposed in the first shaft hole, the retainer ring having a first side, a second side, a central hole and at least one retainer tongue, the first side abutting against the protrusion section, the retainer tongue being annularly disposed in the central hole; and
a bearing positioned in the first shaft hole in tight contact with the retainer ring, the bearing having a first end, a second end and a second shaft hole, the first end abutting against the second side of the retainer ring, the second shaft hole axially extending through the bearing.

8. The cooling fan bearing retainer ring structure as claimed in claim 7, wherein at least one axially extending rib is disposed on an inner wall of the first shaft hole and at least one axially extending groove is formed on an outer circumference of the bearing corresponding to the rib.

9. The cooling fan bearing retainer ring structure as claimed in claim 7, wherein the protrusion section is continuously or discontinuously annularly disposed on the inner circumference of the bearing cup.

10. The cooling fan bearing retainer ring structure as claimed in claim 7, wherein the bearing is selected from the group consisting of oil-retaining powder bearing, ball bearing and ceramic bearing.

11. The cooling fan bearing retainer ring structure as claimed in claim 7, wherein at least one wear plate is disposed at a bottom of the bearing cup in abutment with the second end of the bearing.

12. The cooling fan bearing retainer ring structure as claimed in claim 7, wherein the first end of the bearing has a first tapered hole and the second end of the bearing has a second tapered hole, the first and second tapered holes communicating with the second shaft hole.
